(19) United States
(12) Patent Application Publication
(10) Pub. No.: US 2008/0257801 A1
(43) Pub. Date: Oct. 23, 2008

(54) Device For Filtering Solid Particles For Liquids Containing Such Particles

(75) Inventor: Gidon Neeman, Bet Zera (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignees: Yael Neeman, Ramat Gan (IL); Uri Sandach, Tel Aviv (IL)

(21) Appl. No.: 11/738,534

(22) Filed: Apr. 23, 2007

(51) Int. Cl. B01D 29/52; B01D 29/66

(52) U.S. Cl. 210/108; 210/253; 210/137

(57) ABSTRACT

A filtering device including (a) at least one surface filter element, each including: (i) first and second faces, the second face disposed substantially opposite to the first face, the faces having a first outer contour; (ii) a first opening through the faces, forming a first inner contour of the faces; (iii) a large plurality of grooves disposed on the faces, the grooves connecting between the outer and inner contour, the grooves adapted to trap solid particles; (b) at least one liquid-permeable filter element, each including: (i) third and fourth faces, the fourth face disposed substantially opposite to the third face, the third and fourth faces having a second outer contour; (ii) a second opening through the third and fourth faces, forming a second inner contour of the third and fourth faces, wherein the outer contour of the liquid-permeable element is larger than the outer contour of the surface element, and the third face of the liquid-permeable element is associated with the second face of the surface element to form an integrated filter element, in which: (i) the openings at least partially overlap, and (ii) the outer contour of the liquid-permeable element completely surrounds the outer contour of the surface element.

### FIELD AND BACKGROUND OF THE INVENTION

The present invention relates to a filtering device for filtering solid particles and suspended solids from liquids containing such solids.

Woven materials have been used to filter unwanted particles since man has manufactured cloth materials for clothing, and non-woven materials have been used since before recorded history. Long before Henri Darcy described the flow of liquids through saturated porous material in Dijon, France in 1856, sand bed filters were a known technology for filtering drinking water. These proven methods of clarifying liquid systems from solids and suspended solids are still widely used today.

In bed filters, solid particles are entrapped within the filter medium rather than on the surface as in simple filtering strainers. One major type of bed filters used widely in water and wastewater treatment is the granular filter. The granular filter medium may be sand, crushed volcanic gravel, limestone or basalt gravel, crushed coal-stone, etc. The untreated liquid is pumped on top of the filter medium at up to 15 atmospheres, while the treated filtrate is drained from the bottom of the bed filter. The entrapped particles are periodically removed from the bed filter medium by backwashing, in which vigorous washing of the bed filter medium, with treated water, is used to liberate the entrapped particles from the filter medium. Such back-washing operations are particularly difficult when the bed contains very small grains.

The first modern surface filter, often referred to as a disc filter, was devised in 1936, and served for filtering hydraulic fluid for Boeing's B-17 Bomber. The filter apparatus included a series of firmly stacked stainless steel and brass discs having finely machined grooves on their faces, and a circular opening in the center, which form a hollow core cylinder.

Since then, various surface filter technologies have been used over a wide spectrum of industries and applications, including water treatment, oil refining, pharmaceutical factories and laboratories, wineries, fine liquid chemicals, cosmetics, and vehicle engines. Recent developments including stainless steel manifolds and inexpensive and durable plastic discs, have made surface filter technology adaptable and more cost-effective for the industrial community.

When surface filter elements of the prior art become clogged, the elements need to be backwashed or replaced. Inherently, these operations typically involve high labor and operating costs due to processing shutdowns, a waste of process liquid while discharging contaminated washings and while draining the piping during replacement of spent filter elements.

While two or more parallel systems may be installed to avoid the shutdown of the filtering process during such maintenance procedures, this significantly increases capital investment for the filtration system.

Delaying timely backwashing and delaying timely replacement of spent filter elements both result in an appreciable and unacceptable decrease in liquid flow through the filter (assuming the flow is a constant pressure flow) due to an increase in the resistance to liquid passage through the filter-medium. In extreme cases, a sharp decrease in the quality of the filtered liquid may be observed.

There is therefore a recognized need for, and it would be highly advantageous to have, a surface filter device that overcomes the various shortcomings of the prior art. In particular, it would be highly advantageous to have a surface filter device that greatly increases the filtering capacity of the filter, improves the quality of the filtered material, and lengthens the time interval between backwashing or replacing of the filter elements. It would be of further advantage to have a surface filter device in which backwashing is inherently facile and efficient.

### SUMMARY OF THE INVENTION

According to the teachings of the present invention there is provided a filtering device for separating out solid particles from a liquid containing the solid particles, the filtering device including: (a) at least one surface filter element, each including: (i) a first face and a second face, the second face disposed substantially opposite to the first face, the faces having a first outer contour; (ii) a first opening through the faces, forming a first inner contour of the faces; (iii) a large plurality of grooves disposed on the faces, the grooves connecting between the outer contour and the inner contour, the grooves adapted to trap the solid particles; (b) at least one liquid-permeable filter element, each including: (i) a third face, and a fourth face, the fourth face disposed substantially opposite to the third face, the third and fourth faces having a second outer contour; (ii) a second opening through the third and fourth faces, forming a second inner contour of the third and fourth faces, wherein the outer contour of the liquid-permeable filter element is larger than the outer contour of the surface filter element, and the third face of the liquid-permeable filter element is associated with the second face of the surface filter element to form an integrated filter element, in which: (i) the openings at least partially overlap, and (ii) the outer contour of the liquid-permeable filter element substantially completely surrounds the outer contour of the surface filter element.

According to further features in the described preferred embodiments, the surface filter element is at least a semi-rigid element.

According to still further features in the described preferred embodiments, the liquid-permeable filter element includes a fabric.

According to still further features in the described preferred embodiments, the at least a portion of the first outer contour is generally circular.

According to still further features in the described preferred embodiments, the filter elements are substantially annular.

According to still further features in the described preferred embodiments, the liquid-permeable filter element is directly attached to the surface filter element.

According to still further features in the described preferred embodiments, the surface filter element and the liquid-permeable filter element are made of a substantially identical chemical substance.

According to still further features in the described preferred embodiments, the surface filter element is made of a metallic material.

According to still further features in the described preferred embodiments, the surface filter element is made of a plastic material.

According to still further features in the described preferred embodiments, the plastic material includes polypropylene.

According to still further features in the described preferred embodiments, the fabric is polypropylene.

According to still further features in the described preferred embodiments, the chemical substance is a polymeric substance.

According to still further features in the described preferred embodiments, the at least one surface filter element is a plurality of surface filter elements, and the at least one liquid-permeable filter element is a plurality of liquid-permeable filter elements, such that the integrated filter element is a plurality of integrated filter elements, and the plurality of integrated filter elements is disposed in a stacked orientation such that each first face of the surface filter elements is in contact with a fourth face of an adjacent one of the liquid-permeable filter elements.

According to still further features in the described preferred embodiments, the integrated filter element is substantially annular.

According to still further features in the described preferred embodiments, the outer contours are substantially circular.

According to still further features in the described preferred embodiments, the second outer contour surrounds the outer contour such that at any position on the device, Z>X+Y wherein: Z is a positive differential length between the second outer contour and the first outer contour; X is an average thickness of the surface filter element, and Y is an average thickness of the liquid-permeable filter element.

According to still further features in the described preferred embodiments, Z>3·(X+Y).

According to still further features in the described preferred embodiments, Z>5·(X+Y).

According to still further features in the described preferred embodiments, Z>10·(X+Y).

According to still further features in the described preferred embodiments, the at least one surface filter element is a plurality of surface filter elements, and the at least one liquid-permeable filter element is a plurality of liquid-permeable filter elements, such that the integrated filter element is a plurality of integrated filter elements, and the plurality of integrated filter elements is disposed in a stacked orientation so as to form a stacked plurality of integrated filter elements, the filtering device further including: (c) a housing encompassing the stacked plurality of integrated filter elements; (d) an inlet operatively connected to the housing, the inlet adapted for introduction of the liquid containing the solid particles; and (e) an outlet operatively connected to the housing, the outlet adapted for discharge of a filtered liquid from the filtering device.

According to still further features in the described preferred embodiments, the inlet and the outlet each include a three-way valve.

According to still further features in the described preferred embodiments, the plurality of the filtering device, further includes: (f) a pressure mechanism for providing intimate contact between adjacently-disposed integrated filter elements of the stacked plurality of integrated filter elements, wherein the housing, the inlets, and the stacked plurality are adapted such that a flow of the liquid containing the solid particles and introduced via the inlet passes through, and is filtered by, the stacked plurality to produce the filtered liquid.

According to still further features in the described preferred embodiments, the housing, inlets, and stacked plurality are further adapted such that when the flow is of sufficient pressure, the outer contour of the liquid-permeable filter element bends so as to cover the outer contour of the surface filter element.

According to still further features in the described preferred embodiments, the housing, pressure mechanism, inlets, and stacked plurality are further adapted such that when the flow is of sufficient pressure, the outer contour of the liquid-permeable filter element bends so as to cover the outer contour of the surface filter element and the outer contour of the at least one adjacently-disposed surface filter element.

According to still further features in the described preferred embodiments, the housing, pressure mechanism, inlets, and stacked plurality are further adapted such that when the flow is of sufficient pressure, a pre-coating material in the flow is delivered to, and settles on, the outer contour of the liquid-permeable filter element.

According to still further features in the described preferred embodiments, the pressure mechanism provides a pressure on the stacked plurality such that the liquid-permeable filter element at least partially fills the grooves so as to effectively decrease a cross-section of the grooves.

According to still further features in the described preferred embodiments, the filtering device further includes: (g) a turbine disposed in the housing, arranged with respect to the stacked plurality and the outlet valve such that when a backwashing flow is introduced to the housing via the outlet valve, the turbine produces a stream that overcomes a pressure produced by the pressure mechanism so as to relax the intimate contact and remove the solid particles entrapped within the stacked plurality.

According to still further features in the described preferred embodiments, the filtering device further includes: (h) a mechanism adapted to introduce a pressurized gas to the backwashing flow, so as to enhance removal of the solid particles entrapped within the stacked plurality.

Thus, the present invention successfully addresses the shortcomings of the prior art by providing a filtering device for separating out solid particles from a liquid containing the solid particles. The device efficiently separates suspended solids from liquids, increases filtration capacity, decreases liquid losses due to frequent backwashing or filter elements replacement, and enables facile and efficient backwashing, without prolonged and costly shutdowns.

The present invention is simple, reliable, easy to install, requires little space and requires relatively low capital and maintenance costs.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a top view of a typical grooved surface filter element of the prior art;

FIGS. 2a to 2f are perspective views of the cross-sections of the grooves formed by any two adjacent surface filter elements of FIG. 1, at various points along the length of the grooves;

FIG. 3 is a cross-sectional view of a typical surface filter device of the prior art;

FIG. 4 is a top view of one aspect of the surface filter element having an associated liquid-permeable filter element, according to the present invention;

FIG. 5 is a bottom view of the filter elements of FIG. 4;

FIG. 6 is a schematic cross-sectional view of a stack of the filter elements of FIG. 4, in which is simulated the effect of a liquid passing through the filter device, on the disposition of the filter elements;

FIG. 7 is a schematic perspective view of the cross-sections of the grooves formed by any two adjacent surface and liquid-permeable filter elements in the stacked arrangement shown in FIG. 6;

FIG. 8 is a schematic cross-sectional view of the surface filter element having the associated liquid-permeable filter element shown in FIG. 4;

FIG. 9 is a schematic cross-sectional view of one embodiment of an inventive filter device designed and configured to use the inventive filter elements in a stacked fashion;

FIG. 10a is a schematic top view of the base of the filter device of FIG. 9;

FIG. 10b is a schematic side view of a turbine attached to the lower side of the base of FIG. 10a, according to a preferred embodiment of the present invention, and

FIG. 10c is a schematic top view of the turbine of FIG. 10b.

### DESCRIPTION OF THE PREFERRED EMBODIMENTS

One aspect of the present invention is a filtering device for clarifying liquids containing solids and suspended solids, and more particularly, for clarifying water systems, such as well and river water or wastewater systems, from such solids.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

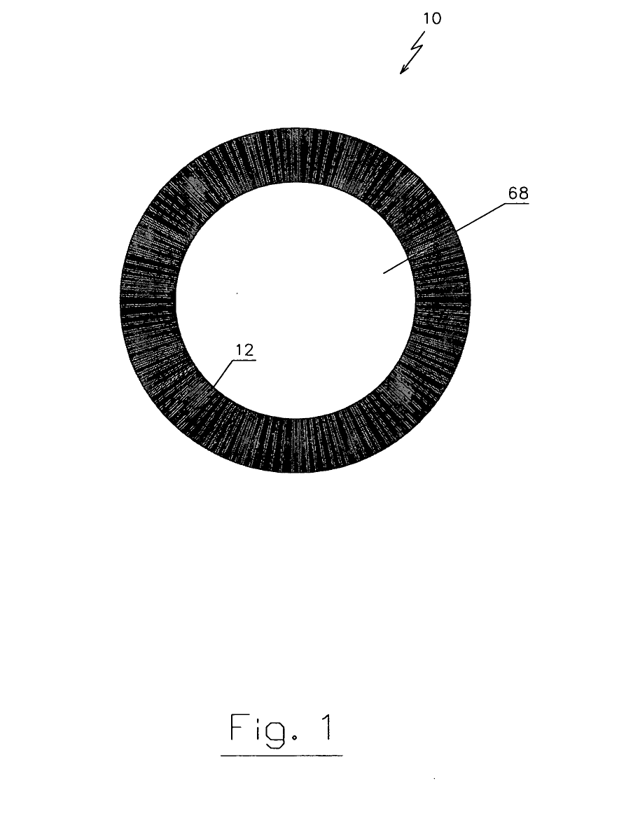

Referring now to the drawings, FIG. 1 is a top view of a typical grooved surface filter element 10 of the prior art. Surface filter element 10 is annular, having an opening 68 in the center. Grooves 12 extend from the outer contour or diameter to the inner contour or diameter of surface filter element 10. The direction of grooves 12 on one face of surface filter element 10 is exactly opposite to the direction of the grooves on the opposing face (not shown). By way of example: if on one face, grooves 12 slant to the left, then on the opposing face, grooves 12 slant to the right.

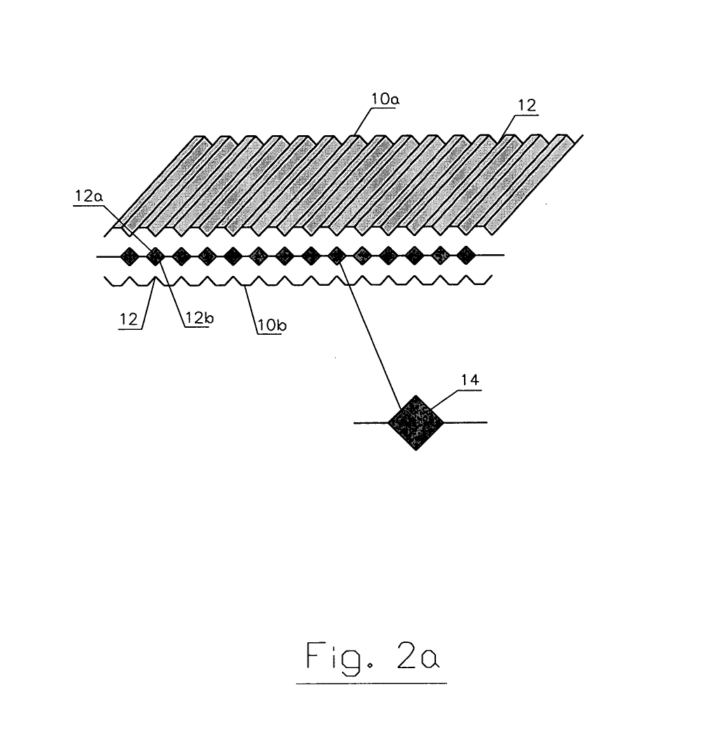

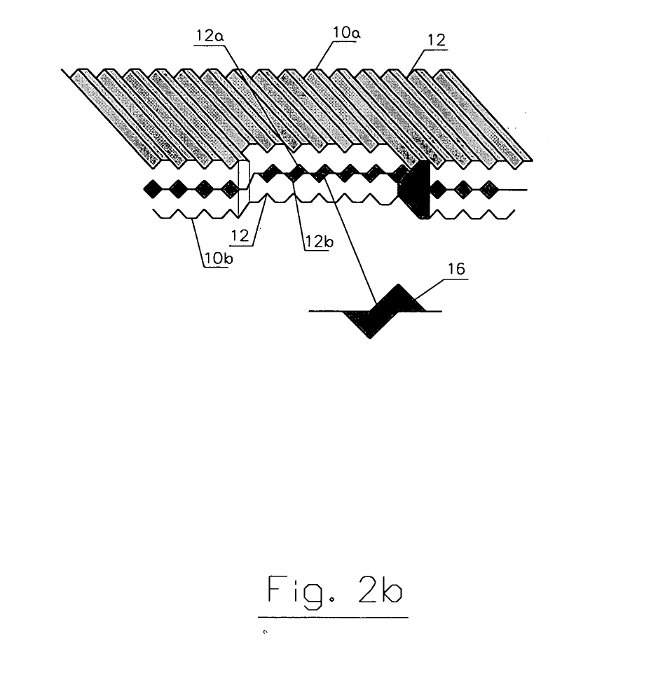

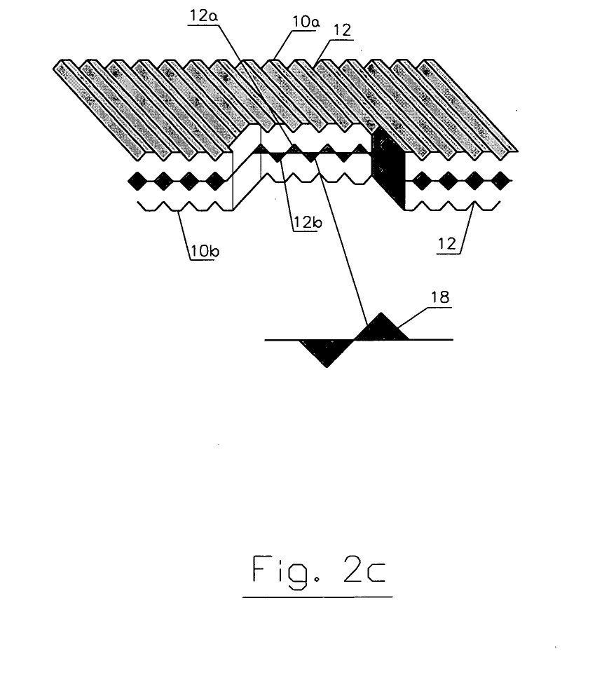

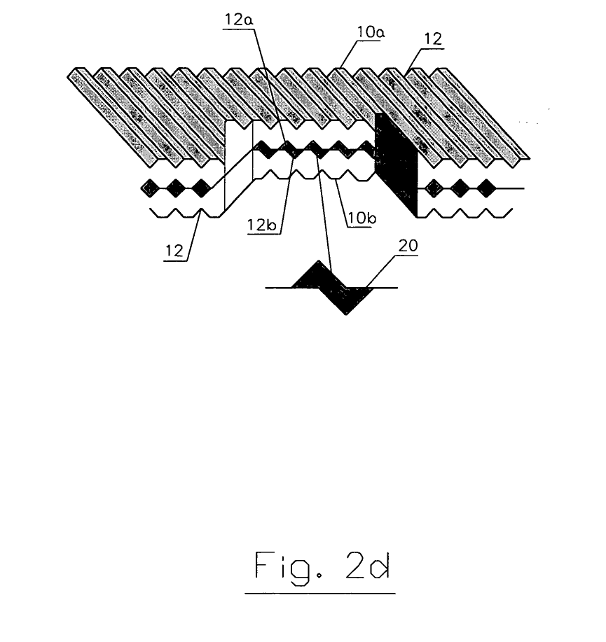

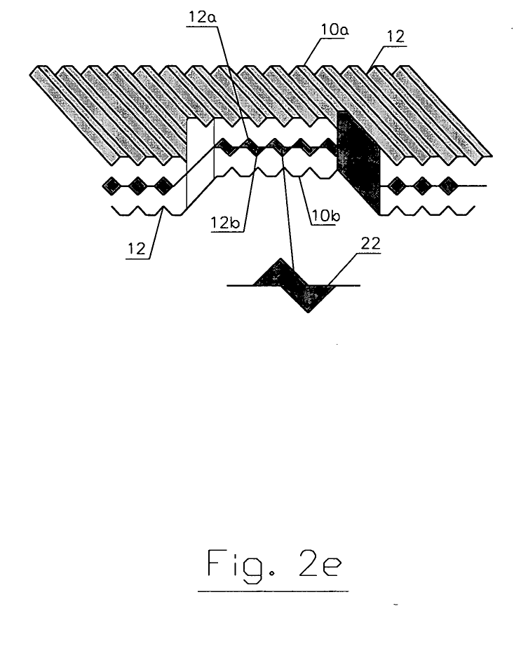

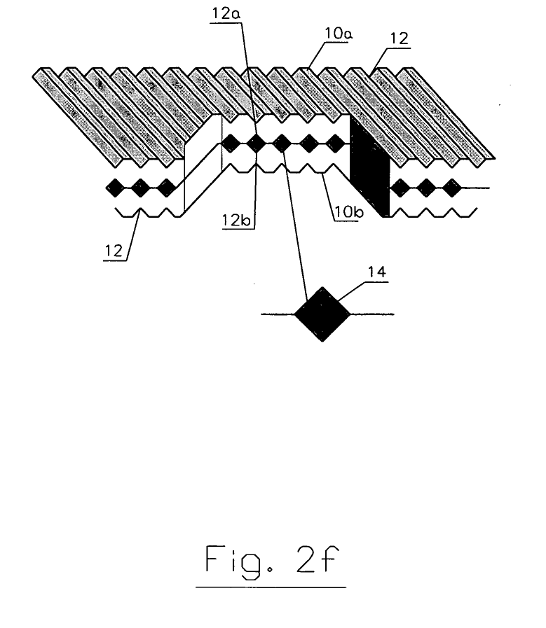

FIGS. 2a to 2f are schematic perspective views of the cross-sectional openings formed, at various points along the length of grooves 12, by any two firmly-stacked adjacent filter elements such as filter element 10. Typically, a large plurality of fine grooves 12 are disposed on both sides or faces of prior art surface filter element 10, so as to form a wavy surface.

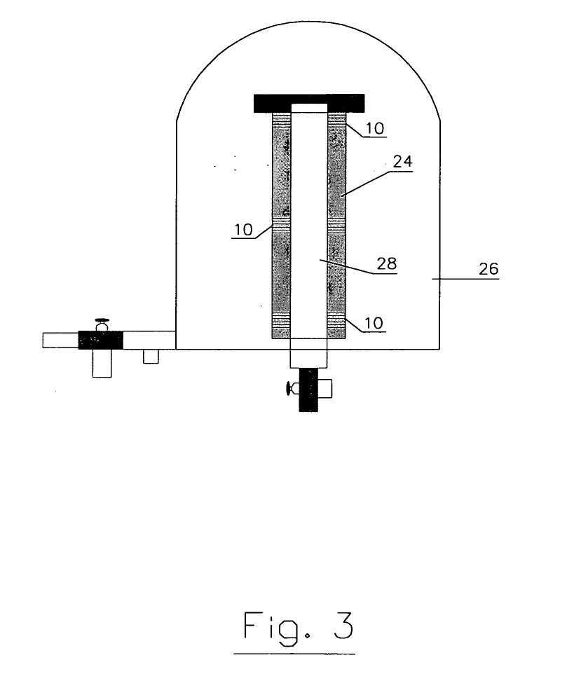

The cross-sectional opening formed by any two adjacent surface filter elements 10a, 10b varies along the length of grooves 12a, 12b as shown in FIGS. 2a to 2f FIG. 2a shows that, as the cross-section of grooves 12a, 12b perfectly align, the cross-section to the flow stream (explained below with reference to FIG. 3) is substantially a rhombic cross-section 14. FIG. 2b shows that the combined cross-section of grooves 12a, 12b further downstream has evolved into two inverted triangles having a partially overlapping base 16. This change in the cross-section of grooves 12 causes turbulence in the flow. The cross-section of the flow path in FIG. 2c is split into two separate triangle sections 18 each with equal cross-sectional areas shearing the flow. As the flow stream moves further along the groove length turbulence is enhanced as the cross-section changes as in FIG. 2d into two inverted triangles with partial common base 20. It should be noticed that cross-section 20 is exactly inverted to cross-section 16. Further on, as shown in FIG. 2e, the cross-section of the flow path is split again into two separate triangle sections 22 each with equal cross-sectional areas shearing the flow. Once again cross-section 22 is exactly inverted to cross-section 20. Further along the groove length the cross-section of two adjacent discs 10, as shown in FIG. 24, evolves into rhombic cross-section 14. Since discs 10 are firmly stacked during operation in a random rotational alignment between any two adjacent discs, the groove cross-section formed by discs 10 randomly varies to all the cross-sections shown in FIGS. 2a to 2f, as well as to all possible intermediate cross-sections. These variations in cross-section result in a turbulent flow through all the firmly-stacked surface filter elements 10.

The flow stream and suspended solid particles move along the length of each groove 12 following many cycles—typically, as many as 10 to 40—of the sequence shown in FIGS. 2a to 2f. A perfectly spherical particle smaller than the separation rating of elements 10 may pass through the filter without entrapment.

However, most suspended particles are irregular in shape, and are more easily entrapped by the varying cross-section as they travel along the length of grooves 12. This varying cross-section has proven to be very effective in separating suspended particles from liquid streams.

Referring now to FIG. 3, FIG. 3 is a cross-sectional view of a typical prior art filter 100 containing a large plurality of surface filter elements. During the filtration process, incoming liquid surrounds a cylindrical stack 24 of firmly-stacked surface filter elements 10, and passes through the groove passages from space 26 outside stack 24 into the interior side 28 of stack 24. While passing through cylindrical stack 24, most of the suspended particles are removed from the stream as described hereinabove.

Due to the fine dimensions of grooves 12, typically between 15 and 500 microns, prior art surface filter elements 10 tend to become blocked or clogged and require frequent backwashing or element replacement.

The present inventive surface filter element and filter device overcome the various shortcomings of prior art filters such as filter 100. The inventive technology lengthens the functional periods between any two consecutive backwashings, and improves the filter efficiency.

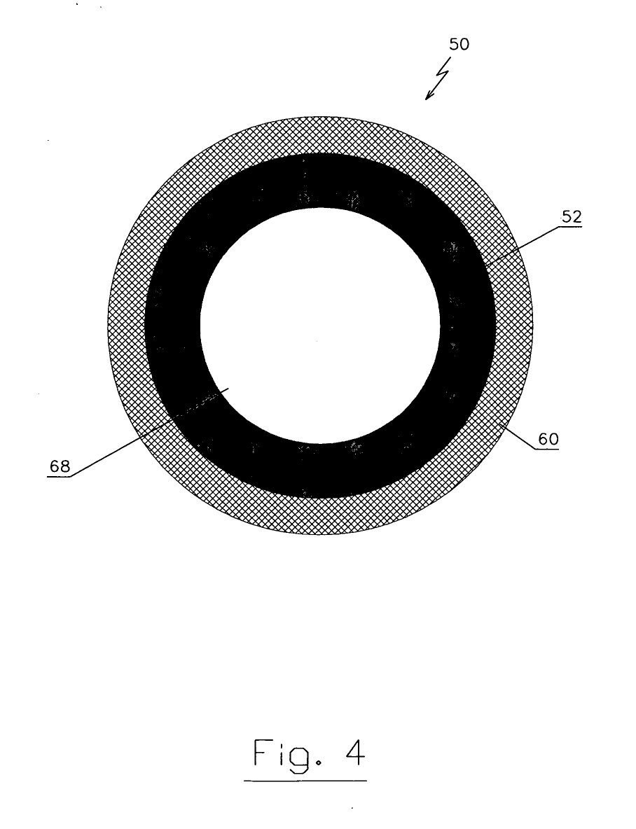

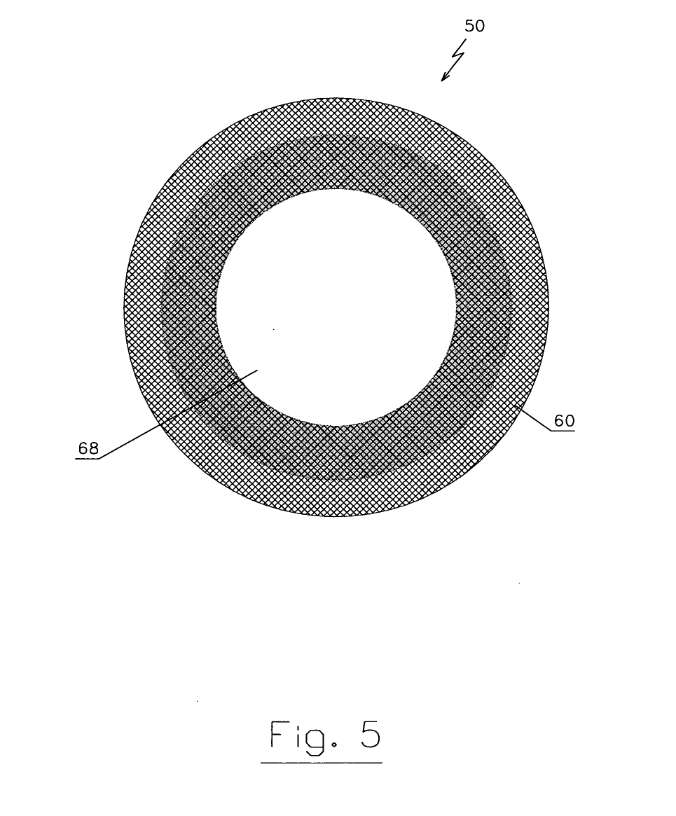

FIG. 4 and FIG. 5 are top and bottom views, respectively, of one embodiment of the inventive filtering device. In these drawings, inventive integrated filter element 50 is a combination of two filter elements: a surface filter element, which is an at least semi-rigid surface filter element 52 similar to prior art surface filter element 10, and a liquid-permeable filter element 60 preferably having the same inner diameter as, or a larger diameter than, surface filter element 52. Surface filter element 52 and liquid-permeable filter element 60 are typically attached at or near the inner contour of liquid-permeable filter element 60, and are usually, though not necessarily, unattached elsewhere. Surface filter element 52 and liquid-permeable filter element 60 have openings 68 in the center that at least partially overlap.

Typically, surface filter element 52 has an outer diameter of between 80 mm and 300 μm, and a thickness of between 0.5 mm and 11.0 mm. Surface filter element 52 usually has at least 500 and more typically, 1000 to 1500 grooves 12 having a characteristic depth of about one fifth to one third of the thickness of element 52. Typically, liquid-permeable filter element 60 has a density of between 150 g/m² to 200 g/m², and is made of a natural material, such as cotton and linen, or a plastic material such as polypropylene, high density polyethylene (HDPE), polyvinyl chloride (PVC), etc., while surface filter element 52 is made of metallic material such as copper, brass and/or stainless steel, or plastic and thermoplastic materials such as polypropylene, polyvinyl chloride (PVC), polyvinylidene fluoride and acrylics.

The association of surface filter element 52 and liquid-permeable filter element 60 may preferably be only at or near the inner contour. As discussed in greater detail hereinbelow, during operation, a plurality of such integrated filter elements 50 are stacked under pressure. Consequently, liquid-permeable filter elements 60 at least partially fill grooves 10 of surface filter elements 52, so as to effectively decrease the cross-section and thus the entrapment efficiency of smaller particles.

It should be emphasized here that integrated filter element 50 is generally disc-shaped or ring-shaped, but, as can be appreciated by those skilled in the art, may have various geometric shapes, such as annular, square, rectangular, etc. In all of these embodiments, grooves 12 are directed between the outer and inner contours of the filter elements.

Integrated filter elements 50 are firmly stacked during operation in a predetermined order, such that every surface filter element 52 is always adjacently-disposed to liquid-permeable filter elements 60, and every liquid-permeable filter element 60 is always adjacently-disposed to surface filter elements 52.

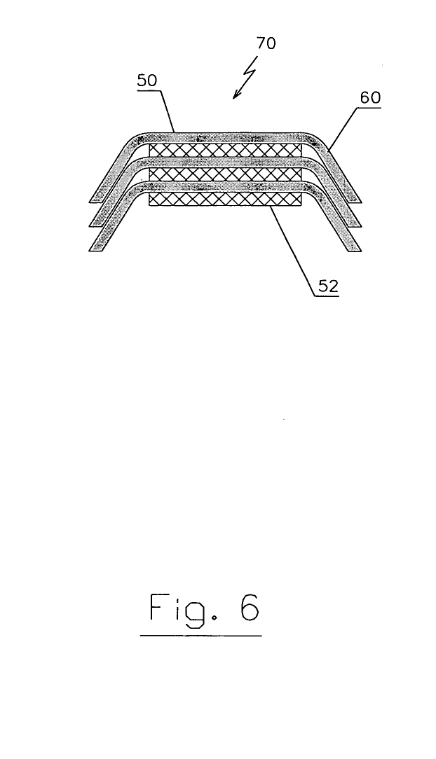

FIG. 6 is a schematic cross-sectional view of a stack of the integrated filter elements 50 of FIG. 4, in which is simulated the effect of a liquid passing through the filter device, on the disposition of the filter elements. Integrated filter elements 50 are firmly stacked during operation to form a stack 70 of such elements. As mentioned hereinabove, the outer contour of liquid-permeable filter elements 60 is larger than the outer contour of surface filter element 52, therefore during a flow of water through stack 70, the water pressure induces the perimeter of liquid-permeable filter elements 60 to bend around so as to cover the outer contour of surface filter element 52. This configuration essentially serves as an additional permeable filtration bed.

It must be emphasized that this additional filtration bed advantageously serves to trap large particles that would otherwise pass through—and block—the grooves of surface filter element 52. Once a bed of such particles has formed against filter elements 60, the bed also advantageously serves to trap small particles that would otherwise pass through the grooves of surface filter element 52 and be discharged in the treated water stream.

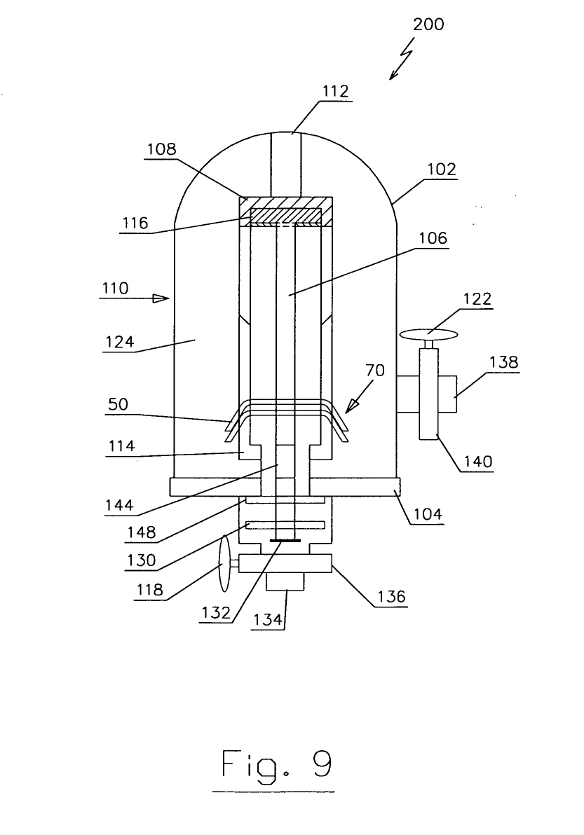

These advantages may be enhanced by optional pre-coating with filtration media such as diatomaceous earth, finely crushed volcanic gravel, sand, activated coal and fibrous materials with or without absorbed chemicals. The pre-coating is preferably performed by feeding a suitable pre-coating material, in suspended form, via the water inlet of the filter device (see FIG. 9 hereinbelow).

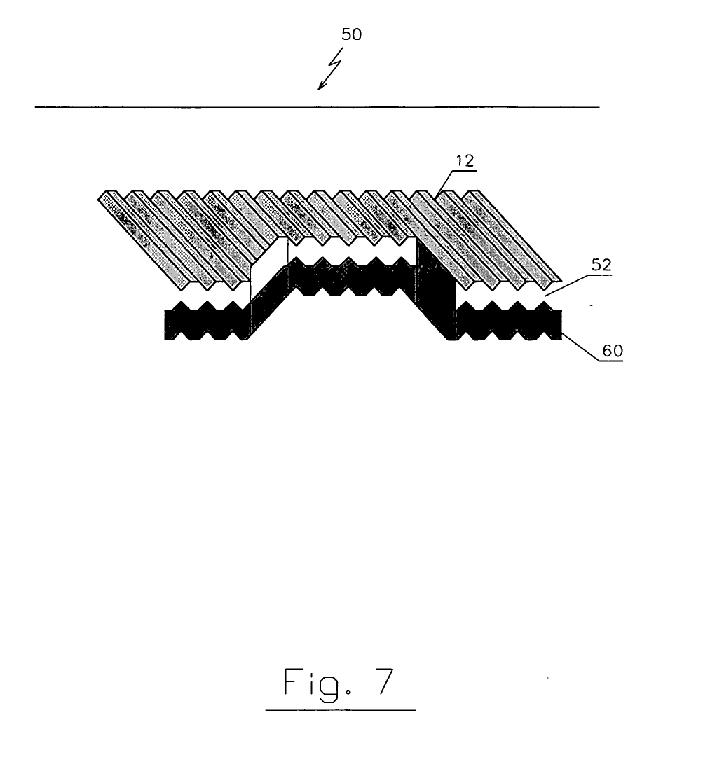

The flow stream cross-section formed by any two adjacent integrated filter elements 50, shown schematically in FIG. 7, is simpler than the flow stream cross-section of prior art surface filter element 10 described in FIGS. 2a to 2f. When integrated filter elements 50 are stacked such that surface filter element 52 faces an adjacent liquid-permeable filter element 60, and when stack 70 is under pressure, grooves 12 are at least partially filled with the soft permeable material of liquid-permeable filter element 60, such that the cross-section substantially remains triangular along the entire length of grooves 12. The permeable material filling grooves 12, described with respect to FIG. 6, enables improved entrapment of particles. Additionally, integrated filter element 50 easily entraps soft organic matter, such as algae, which tends to extrude and shear when differential pressures act upon them.

Typically, the thickness of surface filter element 52 is less than 5 mm, preferably less than 2 mm, more preferably less than 1.5 mm, and even more preferably between 0.6 mm and 1.2 mm; the thickness of permeable fabric disc 60 is less than 2 mm, preferably less than 1.5 mm, and more preferably between 0.5 mm and 0.8 mm.

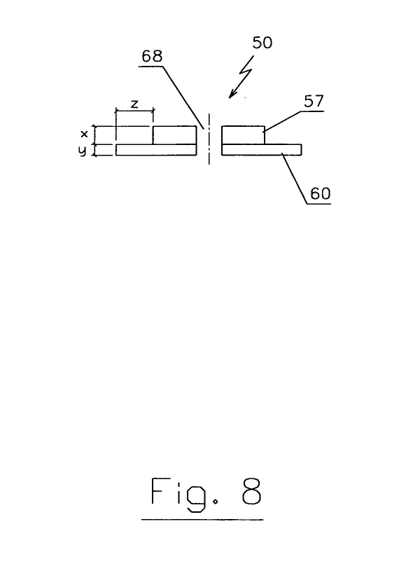

Referring now to FIG. 8, FIG. 8 is a schematic cross-sectional view of integrated filter element 50. In this drawing, Z represents the distance between the contours of liquid-permeable filter element 60 and surface filter element 52, X represents the thickness of surface filter element 52 and Y represents the thickness of liquid-permeable filter element 60.

It has been surprisingly discovered that excellent filtration results are achieved when Z>X+Y, namely, the distance between the outer contours of liquid-permeable filter element 60 and surface filter element 52, is greater than the total thickness of integrated filter element 50. Preferably, Z is greater or equal to about 3·(X+Y); more preferably, Z is greater or equal to about 5·(X+Y); most preferably, Z is greater or equal to about 10·(X+Y).

Referring now to FIG. 9, FIG. 9 is a schematic cross-sectional view of one embodiment of an inventive filter device 200 designed and configured to dispose inventive integrated filter elements 50 in a firmly-stacked fashion so as to form stack 70 of such elements. Inventive filter device 200 includes a housing 110 consisting of an upper element 102 attached to a base 104. Inside housing 110, stack 70 is disposed around a hollow pipe 106 situated along the longitudinal axis of filter device 200. Hollow pipe 106 extends longitudinally so as to pass through base 104. Stack 70 of integrated filter elements 50 (of which only a few are shown) are stacked between a fastening cover 108 and a fixed lower support 114. Fastening cover 108 is associated with hollow pipe 106 by an O-ring 116 to prevent water from bypassing integrated filter elements 50 and penetrating into pipe 106. Such penetration could contaminate the filtered water with turbid, untreated water.

A unique unit for optional use in conjunction with the present invention is a turbine 130, preferably attached around hollow pipe 106, between lower support 114 and a three-way outlet valve 118. The structure and duty of turbine 130 will be explained in detail hereinbelow, after describing the operation of filter device 200.

An untreated water stream is introduced to filter device 200 via a three-way inlet valve 122 at the usual pressure of the external water system. The untreated water in volume 124, disposed outside of stack 70 (partially shown), flows radially through stack 70, leaving behind the suspended solids on the liquid-permeable filter elements and in grooves 12 of the surface filter elements 50. The treated water stream passes turbine 130, which is urged by the water-stream to a final position resting against stopper 132. The treated water stream discharges from filter device 200 via outlet valve 118.

The untreated water in volume 124 circulates tangentially around filtering device 50, causing the unsupported permeable material around the perimeter of liquid-permeable filter element 60 to bend, substantially along the longitudinal axis of filter device 200, as shown in FIG. 6. This bent flap of material practically adds additional filtering area to each integrated filter element 50, so as to enlarge the filtering capacity of filter device 200.

It will be evident to those skilled in the art that integrated filter elements 50 are firmly stacked due to the pressure of a pressure mechanism such as spring 112 exerting pressure on stack 70 by means of cover 108. In addition, pressure on stack 70 is also exerted due to the difference in hydraulic pressure before and after stack 70. The hydraulic pressure differential, usually but not necessarily between 0.5 and 1.0 atmospheres (gage), tends to increase as filter device 200 becomes increasingly loaded with entrapped particles.

During filtration, turbine 130, preferably disposed substantially in perpendicular fashion with respect to hollow pipe 106, revolves freely close to stopper 132, but without blocking the water passage to outlet valve 118.

When stack 70 becomes blocked to a certain extent, backwashing may be required. The backwashing process may be automatic, triggered by a pre-determined set-point of the above-mentioned differential pressure, by a pre-determined timing interval or a combination of both. Alternatively, the backwashing process may be manual.

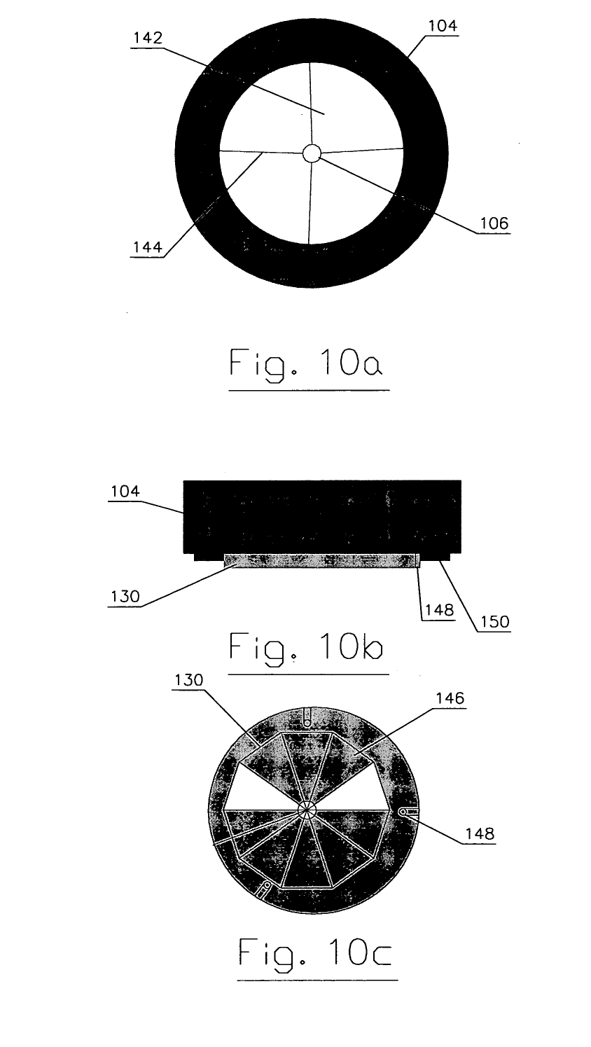

Relating now to FIGS. 9 and 10a to 10c, during backwashing, the flow direction through three-way inlet and outlet valves 122 and 118 is reversed. Outlet valve 118 closes filtered water outlet 134 while opening an inlet 136 of filtered backwashing water. Substantially simultaneously, inlet valve 122 obstructs untreated water inlet 138 and opens a discharge outlet 140 for the spent water containing the solid particles that were entrapped in stack 70.

In another embodiment of the present invention, only a relatively small amount of filtered backwashing water enters filter 200, via inlet 136. Along with the filtered backwashing water is introduced a large volume of pressurized air of between 6 and 12 atmospheres (gage). The reversed water flow pushes turbine 130 away from stopper 132 towards the lower side of base 104, where turbine 130 becomes attached to base 104, for example, by notches 148 on turbine 130 fitting complementary projections 150 protruding from base 104. The free water passage 142 inside base 104, which has the shape of four quarters of a circle formed by a cross-like support 144 holding hollow pipe 106, is substantially closed by turbine 130 so as to deliver only a small amount of water. The water circulates around stack 70 because of the high pressure introduced via outlet 134 and the extremely low pressure in space 124.

The same pressure differential overcomes the pressure exerted by spring 112, thus relaxing the pressure of cover 108 on stack 70. Consequently, integrated filter elements 50 become free to revolve with the backwashing water movement created by the stopped blades 146 of turbine 130 that is now attached to base 104 by notches 148 and projections 150.

The revolving movement of each individual filter element 50 helps to efficiently liberate the particles that were entrapped during the filtration phase of operation. The use of pressurized air advantageously increases the water circulation, so as to quickly liberate the entrapped particles from filter elements 50, and accelerate the discharge of the spent washwater from filter device 200.

After backwashing, the system returns to normal operation by reversing the directions of three-way inlet and outlet valves 122 and 118. If needed or desired, pre-coating materials may be applied at this stage.

It will thus be appreciated by one skilled in the art that the inventive filtering technology:
efficiently separates suspended solids from liquids;
increases filtration capacity;
decreases liquid losses due to frequent backwashing or filter elements replacement;
enables facile and efficient backwashing, without prolonged and costly shutdowns;
requires little space;
has relatively low capital and maintenance costs.
   Water filtered using the inventive filter technology characteristically has a very low NTU and a high removal rate of suspended solids.

### EXAMPLES

Reference is now made to the following examples, which together with the above description illustrate the invention in a non-limiting fashion.

### Example 1

A comparative experiment comparing the turbidity of water filtered by a filter containing inventive integrated filter elements 50 (“Inventive Filter”) with the turbidity of water filtered by two prior art disc filters (“Filter 1”, “Filter 2”) containing conventional surface filter elements 10 was performed under substantially identical conditions. The results are provided in Table 1.

TABLE 1

| Sample No. | Filter 1 | Filter 2 | Inventive filter |
|---|---|---|---|
| 1 | 0.45 NTU | 1.71 NTU | 0.30 NTU |
| 2 | 0.68 NTU | 1.91 NTU | 0.39 NTU |
| 3 | 0.60 NTU | 4.40 NTU | 0.31 NTU |

NTU = Nephlometric Turbidity Unit

### Example 2

Water from the Lake of Galilee, Israel was filtered using a filter device according to the present invention. Sampling was performed before and after filtration. The water inlet pressure was 3.2 atm, the average capacity was 3.5 cubic meter per hour, and the outlet turbidity was 0.36 NTU. Table 2 shows that the overall particle removal efficiency was about 98%, and also provides a breakdown of the particle removal efficiency as a function of particle size.

TABLE 2

| | Inlet | Outlet | Removal (%) |
|---|---|---|---|
| Sampling range (μm) | 2-60+ | 2-33 | |
| TSS (volumetric ppm) | 4.137 | 0.101 | 98% |
| Particles size (μm) | | | |
| 2-5 | 1.258 | 0.019 | 98% |
| 5-10 | 1.460 | 0.017 | 99% |
| 10-15 | 0.632 | 0.018 | 97% |
| 15-20 | 0.252 | 0.020 | 92% |
| 20-30 | 0.386 | 0.025 | 94% |
| 30-40 | 0.085 | 0.003 | 96% |
| 40-50 | 0.035 | 0.000 | 100% |
| >50 | 0.029 | 0.000 | 100% |

TSS = Total Suspended Solids

The examples provided hereinabove clearly demonstrate the exceptional efficiency of filter devices containing integrated filter elements 50, as compared with various filter devices containing conventional surface filter elements. The turbidity of water treated by filters equipped with the inventive integrated filter elements 50 is characteristically lower than the turbidity of water filtered by various presently-available commercial systems. While the total suspended solids (TSS) of the treated water decreased by 98% after filtration, it is especially significant that the removal efficiency remained high even with respect to very small particles of 2-5 μm, which tend to remain in the filtered water in conventional surface filtration.

While much of the above-provided description refers to water as the medium for clarifying, it will be readily understood that the term “water” is meant to refer to other liquids as well.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A filtering device for separating out solid particles from a liquid containing the solid particles, the filtering device comprising:
(a) at least one surface filter element, each including:
(i) a first face, and a second face, said second face disposed substantially opposite to said first face, said faces having a first outer contour;
(ii) a first opening through said faces, forming a first inner contour of said faces;
(iii) a large plurality of grooves disposed on said faces, said grooves connecting between said outer contour and said inner contour, said grooves adapted to trap the solid particles;
(b) at least one liquid-permeable filter element, each including:
(i) a third face, and a fourth face, said fourth face disposed substantially opposite to said third face, said third and fourth faces having a second outer contour;
(ii) a second opening through said third and fourth faces, forming a second inner contour of said third and fourth faces,
wherein said outer contour of said liquid-permeable filter element is larger than said outer contour of said surface filter element,
and wherein said third face of said liquid-permeable filter element is associated with said second face of said surface filter element to form an integrated filter element, in which:
(i) said openings at least partially overlap, and
(ii) said outer contour of said liquid-permeable filter element substantially completely surrounds said outer contour of said surface filter element.

2. The filtering device of claim 1, wherein said surface filter element is at least a semi-rigid element.

3. The filtering device of claim 1, wherein said liquid-permeable filter element includes a fabric.

4. The filtering device of claim 1, wherein at least a portion of said first outer contour is generally circular.

5. The filtering device of claim 1, wherein said filter elements are substantially annular.

6. The filtering device of claim 1, wherein said liquid-permeable filter element is directly attached to said surface filter element.

7. The filtering device of claim 1, wherein surface filter element and said liquid-permeable filter element are made of a substantially identical chemical substance.

8. The filtering device of claim 1, wherein said surface filter element is made of a metallic material.

9. The filtering device of claim 1, wherein said surface filter element is made of a plastic material.

10. The filtering device of claim 9, wherein said plastic material includes polypropylene.

11. The filtering device of claim 3, wherein said fabric is polypropylene.

12. The filtering device of claim 7, wherein said chemical substance is a polymeric substance.

13. The filtering device of claim 1, wherein said at least one surface filter element is a plurality of surface filter elements, and said at least one liquid-permeable filter element is a plurality of liquid-permeable filter elements, such that said integrated filter element is a plurality of integrated filter elements, and wherein said plurality of integrated filter elements is disposed in a stacked orientation such that each first face of said surface filter elements is in contact with a fourth face of an adjacent one of said liquid-permeable filter elements.

14. The filtering device of claim 1, wherein said integrated filter element is substantially annular.

15. The filtering device of claim 1, wherein said outer contours are substantially circular.

16. The filtering device of claim 1, wherein said second outer contour surrounds said first outer contour such that at any position on the device,
Z>X+Y
wherein:
Z is a positive differential length between said second outer contour and said first outer contour;
X is an average thickness of said surface filter element, and
Y is an average thickness of said liquid-permeable filter element.

17. The filtering device of claim 14, wherein Z>3·(X+Y).

18. The filtering device of claim 14, wherein Z>5·(X+Y).

19. The filtering device of claim 14, wherein Z>10·(X+Y).

20. The filtering device of claim 1, wherein said at least one surface filter element is a plurality of surface filter elements, and said at least one liquid-permeable filter element is a plurality of liquid-permeable filter elements, such that said integrated filter element is a plurality of integrated filter elements, and wherein said plurality of integrated filter elements is disposed in a stacked orientation so as to form a stacked plurality of integrated filter elements, the filtering device further comprising:
(c) a housing encompassing said stacked plurality of integrated filter elements;
(d) an inlet operatively connected to said housing, said inlet adapted for introduction of the liquid containing the solid particles; and
(e) an outlet operatively connected to said housing, said outlet adapted for discharge of a filtered liquid from the filtering device.

21. The filtering device of claim 20, wherein said inlet and said outlet each include a three-way valve.

22. The plurality of filtering device of claim 20, further comprising:
(f) a pressure mechanism for providing intimate contact between adjacently-disposed integrated filter elements of said stacked plurality of integrated filter elements,
and wherein said housing, said inlets, and said stacked plurality are adapted such that a flow of the liquid containing the solid particles and introduced via said inlet passes through, and is filtered by, said stacked plurality to produce said filtered liquid.

23. The filtering device of claim 22, wherein said housing, said inlets, and said stacked plurality are further adapted such that when said flow is of sufficient pressure, said outer contour of said liquid-permeable filter element bends so as to cover said outer contour of said surface filter element.

24. The filtering device of claim 22, wherein said housing, said pressure mechanism, said inlets, and said stacked plurality are further adapted such that when said flow is of sufficient pressure, said outer contour of said liquid-permeable filter element bends so as to cover said outer contour of said surface filter element and said outer contour of said at least one adjacently-disposed surface filter element.

25. The filtering device of claim 23, wherein said housing, said pressure mechanism, said inlets, and said stacked plurality are further adapted such that when said flow is of sufficient pressure, a pre-coating material in said flow is delivered to, and settles on, said outer contour of said liquid-permeable filter element.

26. The filtering device of claim 22, wherein said pressure mechanism provides a pressure on said stacked plurality such that said liquid-permeable filter element at least partially fills said grooves so as to effectively decrease a cross-section of said grooves.

27. The filtering device of claim 22, further comprising:
(g) a turbine disposed in said housing, arranged with respect to said stacked plurality and said outlet valve such that when a backwashing flow is introduced to said housing via said outlet valve, said turbine produces a stream that overcomes a pressure produced by said pressure mechanism so as to relax said intimate contact and remove the solid particles entrapped within said stacked plurality.

28. The filtering device of claim 27, further comprising:
(h) a mechanism adapted to introduce a pressurized gas to said backwashing flow, so as to enhance removal of the solid particles entrapped within said stacked plurality.
